(19) United States
(12) Patent Application Publication
(10) Pub. No.: US 2026/0056918 A1
(43) Pub. Date: Feb. 26, 2026

(54) AI Cloud Recycle Bin

(71) Applicant: Timothy John Ryder Shinkle, Alexandria, VA (US)

(72) Inventor: Timothy John Ryder Shinkle, Alexandria, VA (US)

(21) Appl. No.: 19/247,930

(22) Filed: Jun. 24, 2025

Related U.S. Application Data
(63) Continuation-in-part of application No. 18/160,956, filed on Jan. 27, 2023, now abandoned.
(60) Provisional application No. 63/313,976, filed on Feb. 25, 2022.

(51) Int. Cl. G06F 16/17; G06F 40/30

(52) U.S. Cl. CPC G06F 16/1727; G06F 16/1734; G06F 40/30

(57) ABSTRACT

A cloud-based AI Recycle Bin (AiRB) utilizes an autonomous predictive file management system. The method allows users to configure initial settings, select default templates, and set data processing workflows. Users can install scan agents on multiple devices, identify storage locations with necessary permissions, and designate target recycle bin locations in the AiRB cloud. The system schedules background scans to identify unnecessary data based on predefined rules. Approved results are copied to the recycle bin, prompting users to delete the corresponding source data. The method includes executing operational commands, applying rule patterns and search filters to scans, and configuring auditing and reporting dashboards for oversight. Additionally, it facilitates automated billing and account management, enhancing efficiency in data management and storage optimization.

### FIELD OF THE INVENTION

The present invention generally relates to a cloud-based artificial intelligence (AI) solution known as the AI Recycle Bin (AiRB). More specifically, the present invention relates to a subscription-based service that enables consumers and organizations to automatically cleanse and manage data over time by utilizing AI to identify, archive, restore, or delete unnecessary files. At its core is an autonomous predictive file management system that analyzes user behavior and file usage patterns, predicting which data can be removed while efficiently managing relevant information in the background.

### BACKGROUND OF THE INVENTION

The cloud data storage market is projected to reach USD 390.33 billion by 2028. This growth underscores the significant expenses incurred by organizations and consumers in storing data both on-premises and in the cloud, much of which is no longer necessary. Currently, there is no efficient method for effectively eliminating this superfluous data. Many organizations and consumers possess considerable potential for data storage savings if the right price point and level of effort are applied.

While various crawl technologies exist to assist with data cleanup, these solutions are typically costly and primarily designed for large organizations to implement on-premises rather than in cloud environments. Moreover, they do not effectively leverage artificial intelligence (AI) and machine learning (ML) techniques, particularly reinforcement learning, to ascertain what data is no longer required or to provide a recycle bin storage location. These crawl technologies necessitate installation on a server, whether on-premises or in the cloud, and involve substantial manual effort to cleanse data at scale.

Conversely, other available solutions that include a recycle bin functionality do not employ crawl technologies or utilize AI and machine learning to proactively identify unnecessary data. They also fail to implement workflow processes that can automatically clean data over time. A simpler and more cost-effective method is needed—one that can asynchronously begin scanning a customer's data storage, including on-premises data centers, servers, client computers, devices, cloud storage, and third-party social media platforms. This method should identify and cleanse data that is no longer needed while continuously running in the background as a service that can scale with demand.

The objective of the present invention is to provide a cost-effective and automated approach to cleansing data and storing it in a recycle bin, allowing for cleansed data to be archived, restored, or permanently deleted. Accordingly, the present invention, referred to as AiRB, operates as a software-as-a-service (SaaS) solution that offers a subscription-based service for consumers and organizations, leveraging AI and machine learning to automatically manage and cleanse customer data over time. To achieve this, AiRB comprises multiple software components, including a cloud-hosted SaaS web-based front end that facilitates user sign-up and service operation, along with a robust software backend consisting of a database, an indexing engine, a business rules and inference engine, AI natural language processing (NLP) classifiers, machine learning with reinforcement learning features, a reporting tool, a cloud-based container orchestration platform, a storage broker, and integrated cloud storage solutions. Furthermore, the service includes customizable rules that can be modified, trained, or created to identify patterns in user behavior related to temporary data creation, and to label data that may be unnecessary. These rules are integrated with compliance requirements, ensuring that users can effectively manage data retention while adhering to vital business regulations.

The present invention is intended to solve the problems associated with conventional devices and methods and provide improvements on these devices.

### SUMMARY OF THE INVENTION

This summary serves to introduce a selection of concepts in a simplified form, which are further elaborated in the Detailed Description. This summary is not intended to define key or essential features of the claimed subject matter and should not be used to limit the scope of the claims presented herein.

The present invention is a cost-effective, automated approach to cleansing and managing data through a recycle bin, wherein cleansed data can be archived, restored, or permanently deleted. Specifically, the invention, called AiRB, operates as a software-as-a-service (SaaS) solution that offers a subscription-based platform for consumers and organizations. It leverages artificial intelligence (AI) to effectively cleanse and manage customer data automatically over time.

Central to this invention is an autonomous predictive file management system designed to enhance data organization and usability. This system utilizes advanced algorithms to analyze file usage patterns, predict future data utility, and streamline the decision-making process regarding data retention and deletion. By leveraging machine learning and reinforcement learning techniques, the system adapts to user behavior and continually improves its predictions and recommendations.

To achieve these objectives, the present invention includes several software components and services. It features a cloud-hosted SaaS web-based front end that facilitates account management and allows users to sign up for and operate AiRB services. The backend consists of a robust architecture that includes a database for storing data and metadata, an indexing engine that organizes and retrieves data efficiently, and a business rules and inference engine for applying defined data management protocols. Additionally, it incorporates AI components such as natural language processing (NLP) classifiers that enhance data understanding and machine learning (ML) algorithms that utilize reinforcement learning to adapt and improve based on user feedback. The system also integrates a reporting tool that provides insights into data management activities, a cloud-based container orchestration platform that ensures scalable deployment of services, and a storage broker that optimizes data storage solutions. Integration with cloud storage services ensures secure and efficient data management.

Moreover, the service encompasses customizable rules that can be modified, trained, or created to identify user behavior regarding temporary data creation and label data that may be no longer needed. These rules are further integrated with compliance requirements to ensure that critical data retention policies are adhered to, thereby aiding businesses in managing their data in a compliant manner.

### BRIEF DESCRIPTION OF THE DRAWINGS

FIG. 1 is a block diagram representing a system overview of the present invention.

FIG. 2 is a flow diagram illustrating front-end processes or a user-end workflow of the present invention.

FIG. 3 is a flow diagram illustrating the system workflow of a method of operation, according to a preferred embodiment of the present invention.

FIG. 4 a flow diagram illustrating back-end workflow of the system according to the preferred embodiment.

FIG. 5 is a flow diagram illustrating back-end workflow of the system according to the preferred embodiment.

FIG. 6 is a block diagram representing the autonomous predictive file management System of the present invention.

FIG. 7 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

While embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications May be made to the elements illustrated in the drawings. The methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subject matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, and at least one network device.

Examples of the one or more client devices and/or the server computer May include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on.

Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

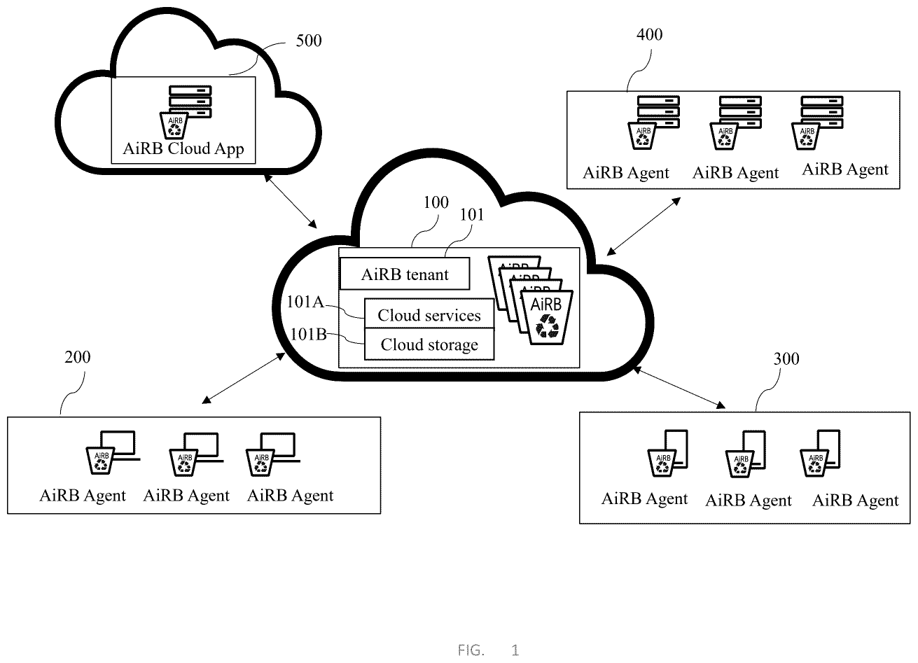

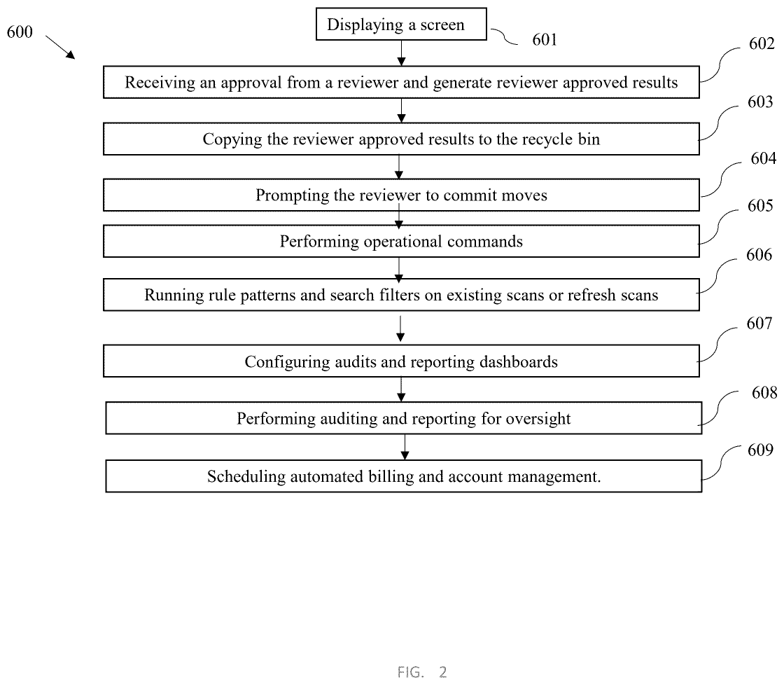

In reference to FIG. 1 through FIG. 5, the present invention is a Cloud based AI Recycle Bin (AiRB). An objective of the present invention is to provide a cost-effective and automated approach to cleansing data and storing it in a recycle bin, wherein the cleansed data can be archived, restored or permanently deleted.

Accordingly, the present invention (AiRB) is a software-as-a-service (SaaS), which provides a subscription-based offering for consumers and organizations that leverage AI to effectively cleanse a customer's data automatically over time.

To accomplish this, the present invention comprises several software components, a cloud hosted SaaS web based front end and account management services to sign up, manage and run the other services, a software backend consisting of a database, indexing engine, business and inference rules engine, workflow and messaging engine, AI natural language processing (NLP) classifiers for classifying customer data, AI machine learning (ML) using reinforcement learning from user feedback to continually learn and improve on results, reporting tools, a cloud-based container-orchestration platform, a storage broker, and cloud storage. Further, according to the present invention, the service includes rules that can be modified, trained or created to identify human habits of creating temporary data and labelling data as potentially no longer needed, combined with rules around data they might need to keep or delete for business compliance reasons.

The following description is in reference to FIG. 1 through FIG. 5. In reference to FIG. 1, the present invention depicts one embodiment of the AiRB solution.

The AiRB cloud service is a multi-tenant SaaS offering that allows customers to sign up and start processing their data immediately, identifying what is no longer needed and staging in a recycle bin where it can be archived, restored or permanently deleted.

### a More Detailed Description of the Invention's Components.

As shown in FIG. 1, the present invention includes Ai Recycle Bin (AiRB) cloud SaaS Multi-Tenant Platform 100. The Ai Recycle Bin (AiRB) cloud SaaS Multi-Tenant Platform 100 is a multi-tenant cloud software-as-a-service (SaaS) platform where the Ai Recycle Bin (AiRB) software services are run and maintained on computer servers in the cloud for many customers each running their own AiRB tenant 101.

The AiRB tenant 101 is an independent customer AiRB instances of AiRB cloud services 101A and AiRB recycle bin cloud storage locations (cloud storage) 101B.

The cloud services 101A is a cloud hosted SaaS web based front end and account management services to sign up, manage and run the other services, a software backend consisting of a database, indexing engine, business and inference rules engine, workflow and messaging engine, AI natural language processing (NLP) classifiers for classifying customer data, AI machine learning (ML) using reinforcement learning from user feedback to continually learn and improve on results, reporting tools, a cloud-based container-orchestration platform, a storage broker, and cloud storage.

The cloud storage 101B is recycle bin storage locations in the cloud for storing data that is either moved from, or, synchronized with the source storage locations that include customer computers 200, customer devices 300, customer storage network 400, and customer cloud storage 500.

The customer computers running AirB agent 200 is an AiRB service agent that performs local client activities on the customer's computers and provides a cached recycle bin storage location that is synchronized with the AiRB cloud storage. The local agent can crawl the local computer storage, upload the results of the crawl to the AiRB cloud for analysis, notify the customer computer with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the computer is back online for exchanging data with the cloud and providing updates.

The customer devices running AirB agent 300 is an AiRB service agent that performs local client activities on the customer's devices such as smartphones and other internet devices and provides a cached recycle bin storage location that is synchronized with the AiRB cloud storage. The local agent can crawl the local devices storage, upload the results of the crawl to the AiRB cloud for analysis, notify the customer device with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the device is back online for exchanging data with the cloud and providing updates.

The customer storage network running AirB agent 400 is an AiRB service agent that performs local client activities on the customer's storage network and provides a cached recycle bin storage location that is synchronized with the AiRB cloud storage. The local agent can crawl the local storage network, upload the results of the crawl to the AiRB cloud for analysis, notify the customer's AiRB account (or via email) with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the device is back online for exchanging data with the cloud and providing updates.

The customer cloud Storage running AirB agents 500 is an AiRB service agent that performs local client activities on the customer's cloud storage and provides a cached recycle bin storage location that is synchronized with the AiRB cloud storage. The local agent can crawl the local cloud storage, upload the results of the crawl to the AiRB cloud for analysis, notify the customer's AiRB account (or via email) with a tickler of pending actions for approval, then perform local actions such as move data to the local AiRB recycle bin cache, where moved data is subsequently uploaded to the AiRB cloud recycle bin leaving a local link and an option to search and restore data back from the AiRB cloud to the original or different storage location as needed. The local agents can behave as an independent asynchronous AiRB recycle bin service that performs crawls, runs rules, performs analysis, generates reports, provides results, and takes actions, all locally offline, synchronizing with the AiRB cloud services once the cloud is back online for exchanging data with the AiRB cloud and providing updates.

### Additional AiRB Services Details:

Services include account management. This provides the ability to sign up new accounts, manage users, roles, billing, and security such as authentication and encryption. Storage management. This provides services for monitoring and managing recycle bin storage locations across all storage locations, cloud storage, storage networks, computers, and devices. The dashboards showing results and actions taken over time, agent management showing what agent apps are installed on what devices across the organization, Ai and rules management, storage management, reporting, disposition processing and other related services.

API integration services. This provides connections to third-party systems and applications to crawl and manage third-party data sources.

AiRB transportable rules and industry default classifiers. The rules can be exported and exchanged between AiRB tenants allowing for sharing rule sets between customers and defining default rule sets for different industries including rules, laws and regulations on records retention management. This includes default classifiers for different customer industries and needs that can be shared and improved over time.

AiRB Rules. The rules include the ability to analyze data based on extensions, data locations and identifiers, such as file paths and file names, content, search queries, human habits, AI for classification including NLP entity extraction, names, image searches, and OCR searches. Rules can be built-on other rules and leverage Boolean logic to build more complex rules. AI features include supervised and semi-supervised learning for classification, and reinforcement learning for iterative understanding of what data needs are to the users such as being no longer needed or critically important, active, inactive, or needs to be kept indefinitely. Examples of rules include but are not limited to the following:

| Rule | Description |
|---|---|
| 1. Temporary_Files | Files that get created by Microsoft |
| | Office and other applications for |
| | temporary purposes while running |
| | that sometimes do not get cleaned up |
| | after the application is closed. |
| 2. Old_Sys_Gen_Backup | System/application generated backup |
| | files that are at least 3 years old. |
| 3. Zero_Content | Files that do not contain any content |
| | and can be cleaned up for decluttering. |
| 4. Obsolete_Install | Files that were used for installing an |
| | application or computer backups that |
| | are likely no longer needed. |
| 5. Old_Drafts | Files that have been identified as draft |
| | in the filename or path (e.g., draft, ver2, |
| | v1.0, v3, etc . . .) and are greater than 1 |
| | year old. |
| 6. Human_ID_Backup | Files have been identified as backup or |
| | copy of in the file name or path. |
| 7. Old_Abandoned_Apps | Application or configuration files that |
| | are greater than 3 years old. |
| 8. PC_Backup | Files that have been identified as |
| | backup files in the filename or path |
| | (e.g., temporary internet files, my |
| | documents, downloads). |
| 9. Human_ID_Deletable | Files that have been identified as |
| | deletable in the filename or path (e.g., |
| | trash, garbage, delete, remove, to be |
| | deleted, cleanup folder). |
| 10. Human_ID_Old | Files that have been identified as old or |
| | superseded in the filename or path (e.g., |
| | old, outdated, superseded). |
| 11. Old_Sys_Status_Reporting | Files generated by a system or |
| | application that are greater than 3 years |
| | old. |
| 12. Other_Old Files | Files older than 7 years that may not |
| | be in the other reports but may no |
| | longer be needed. |
| 13. Large Files | Files that are larger than the average file |
| | (at least 12MB in size) and represent a |
| | potential for storage space recovery and |
| | decluttering. |
| 14. Old_Photos | Photos found that are over 7 years old. |
| 15. Old_Rich_Media | Multi-media files found over 7 years |
| | old. |
| 16. Compressed Duplicates | Files that have been compressed or |
| | zipped and left in place with the original |
| | non-compressed file. |
| 17. Duplicates | Duplicate files that may no longer be |
| | needed. Note: A general rule can be |
| | requested to keep the oldest or youngest |
| | duplicate and dispose of the rest. |
| 18. Renditions | Files that are renditions of other files in |
| | the same location, such as a PDF |
| | version of a MS Word document. |

According to a preferred embodiment, a method of operation of the present invention comprises the following steps.

The method 600 of the present invention comprises displaying a screen 601, wherein the screen can include any electronic visual display device (e.g., a phone screen, computer monitor, including a liquid crystal display (LCD) or a light emitting diode (LED) display). Further, the screen can include any interface capable of presenting information that can be viewed by a user or a reviewer.

The screen can be configured to allow a user to: choose an initial setting, choose a default configuration template, choose default data processing workflows, download and install scan agents on a plurality of devices, identify and provide permissions to a plurality of storage locations, for each agent, configure a target recycle bin storage location in AiRB Cloud; schedule the agents to scan and refresh scans as a background service with rules, and review results. The user can review the results with search filters and suggestions for approving and moving files to the recycle bin.

The method 600 further includes steps of: receiving an approval from a reviewer and generate reviewer approved results 602; copying the reviewer approved results to the recycle bin 603; prompting the reviewer to commit moves by deleting copied source data 604; performing operational commands 605, wherein the operational commands can include Create, modify or delete commands or any other commands to operate the present invention;
running rule patterns and search filters on existing scans or refresh scans 606; configuring audits and reporting dashboards 607; performing auditing and reporting for oversight 608; and scheduling automated billing and account management 609.

In one embodiment, the initial setting may include an account type, consumer and organization. The workflows may include schedules for sending email ticklers to reviewers. The plurality of devices may include PCs and servers.

The plurality of storage locations may include local, networked, and cloud storage locations for scanning. The configuration of the target recycle bin storage location may include an option to leave links in the local bin.

In some embodiments, the default configuration template may include: rules and Ai classifiers for identifying files (data) for cleansing including consumer patterns for personal data files or patterns based on industry templates containing relevant document types and regulatory retention requirements for an organization's data files.

The method 600 may further include a step of displaying a screen that allows the user to add additional admin and reviewer accounts.

The method 600 may further include a step of displaying a screen that allows the user to choose third party cloud-2-cloud agents for scanning and processing data in third-party clouds through API integration services.

The rules can be configured for data volume limits, refresh cycles, dates, times for stopping, restarting scans due to network traffic and sending ticklers to reviewers for reviewing and taking action on results.

The method 600 may include performing operational commands for: agents with additional data sources, rules, custom trainable Ai data classifiers, default rules and search filters, scans for cleansing and training custom classifiers, and trained classifiers associated with rule patterns.

In use, the user can operate the present invention with following steps:
1. Navigate to the Ai Recycle-Bin (AiRB) website at 701. (AiRB website may include a plurality of web pages designed to operate the present invention and a user interface implemented as a graphical user interface (GUI) with a plurality of buttons that can be configured to interact with a user). 8
2. Choose an account type, consumer or organization at 702.
3. Choose a default configuration template containing rules and Ai classifiers for identifying files (data) for cleansing including consumer patterns for personal data files or patterns based on industry templates containing relevant document types and regulatory retention requirements for an organization's data files at 703.
4. Add additional admin and reviewer accounts at 704 as needed.
5. Choose default data processing workflows with schedules for sending email ticklers to reviewers at 705.
6. Download and install scan agents on devices, PCs and servers (Windows, macOS, Linux, Unix, IOS, Android, Cloud VMs) at 706.
7. Choose third party cloud-2-cloud agents for scanning and processing data in third-party clouds (e.g., Facebook data) at 707.
8. For each agent, identify and provide permissions to local, networked, and Cloud storage location(s) for scanning at 708.
9. Configure target recycle bin storage location in AiRB Cloud with option to leave links in local bin as feasible at 709.
10. Schedule agent(s) to scan and refresh scans as a background service with rules for data volume limits, refresh cycles, dates, and times for stopping and restarting scans due to network traffic and sending ticklers to reviewers for reviewing and taking action on results at 710.

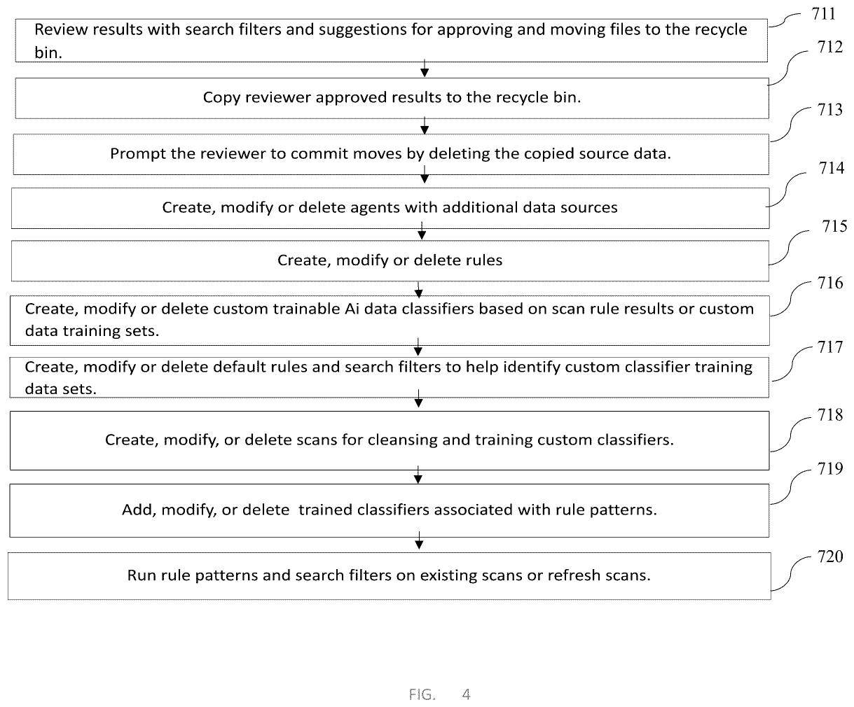

As shown in FIG. 4 (back-end workflow of the system), the), the steps continue as follows:
11. Review results with search filters and suggestions for approving and moving files to the recycle bin at 711 (This step informs the AI reinforcement learning algorithm in the process where the system learns from user feedback and provides an option to auto-update the rules and results with learned patterns from the reviewed results and improve rule accuracy over time, this includes auto-adjusting the classifier training sets for retraining the classifiers with more accurate representative data sets).
12. Copy reviewer approved results to the recycle bin at 712.
13. Prompt the reviewer to commit moves by deleting the copied source data at 713.
14. Create, modify or delete agents with additional data sources at 714.
15. Create, modify or delete rules at 715.
16. Create, modify or delete custom trainable Ai data classifiers based on scan rule results or custom data training sets at 716.
17. Create, modify or delete default rules and search filters to help identify custom classifier training data sets at 717.
18. Create, modify, or delete scans for cleansing and training custom classifiers at 718.
19. Add, modify, or delete trained classifiers associated with rule patterns at 719.
20. Run rule patterns and search filters on existing scans or refresh scans at 720.

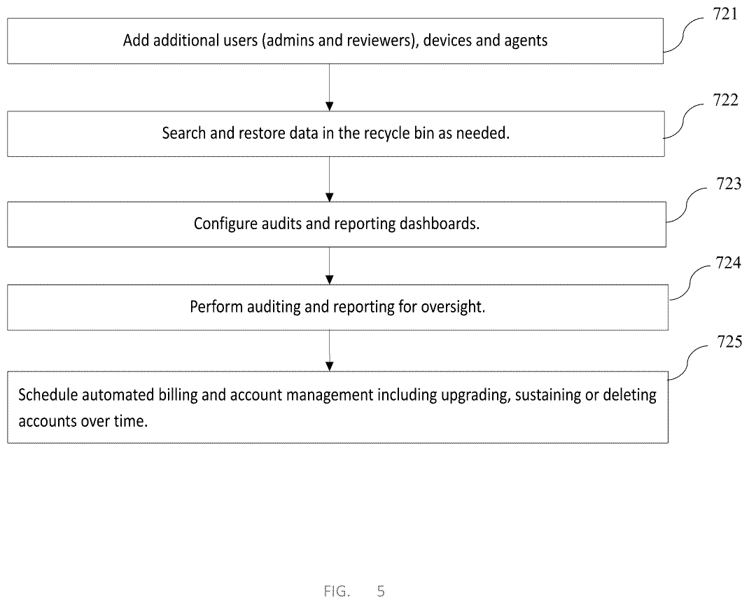

As shown in FIG. 5 (back-end workflow of the system), the steps may continue as follows:
21. Add additional users (admins and reviewers), devices and agents at 721.
22. Search and restore data in the recycle bin as needed. at 722.
23. Configure audits and reporting dashboards at 723.
24. Perform auditing and reporting for oversight at 724.
25. Schedule automated billing and account management including upgrading, sustaining or deleting accounts over time at 725.

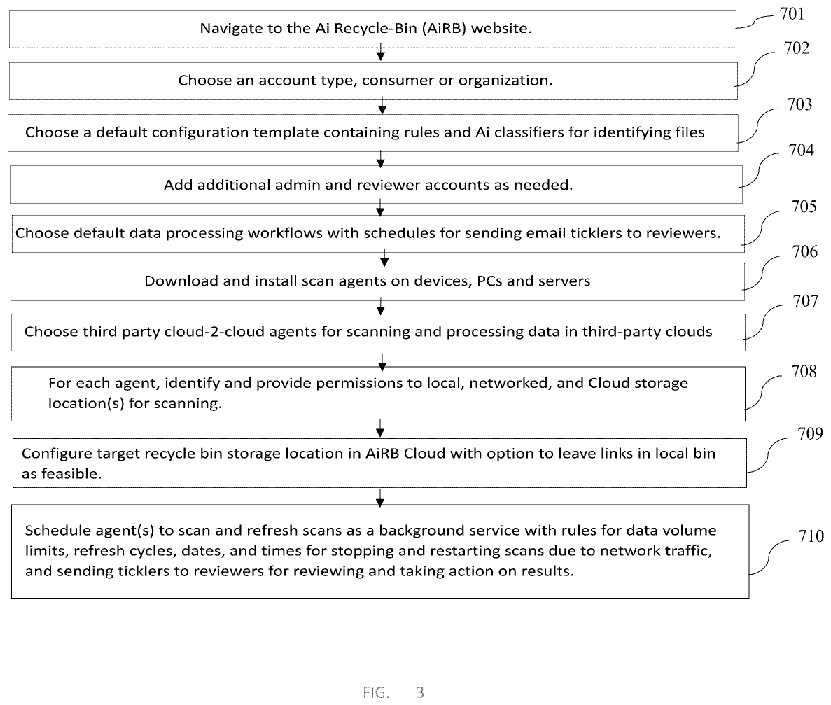

As seen in FIG. 3, and as shown in steps 701 through 710, a set of front-end processes or user-end steps involve choosing an account type, consumer or organization. In other words, the present invention enables users to select a plan according to their needs and budget. Accordingly, the present invention may scale up the package and requirements for bigger corporations and scale down for individuals.

In reference to FIG. 4 and as shown in steps 711 through 720, the present invention allows users to create, modify, or delete rules, agents, AI data classifiers etc. at any point of time. This will enable the program to learn and adapt to the user's needs with time.

As seen in FIG. 5 as shown in steps 721 through 725, the user can further add agents, search and restore data from the recycle bin, perform auditing and make changes to the account. All these features make the present invention customizable, efficient, and user-friendly.

According to the present invention, in some embodiments, the components can be put together in a backend software platform with server components and services running in cloud-based containers hosted by a cloud vendor platform. A cloud web front end running in a browser is provided to perform customer interaction, service usage, reporting, and administration. The rules are transportable in a native rule engine language and can be uploaded and stored in the backed database. The rules can be considered add-ons and shared across customers. Reports can also be exported, shared, marked up in spreadsheet or CSV format and imported back into the cloud service for processing. The AI classifiers can be unique to each customer or shared as based on anonymous cleansing of customer data and customer approval for training the classifiers on generic data types found across different customers. The front end provides sign up and account management, a user-interface (UI) to administer the service and a UI for reviewing and processing the results. Each customer will have their own instance of the services for their personal or business use.

The recycle bin storage is cloud-based storage negotiated with cloud vendors for cost-effective long-term storage of inactive data. Customers will pay for both processing data and for storing data in the recycle bin. The recycle bin can be exposed as an agent running on the operating system of the customers computer device or devices. Customers who cancel their service can download their recycle bin data or move it to another cloud vendor prior to cancelation.

Thus, the present invention provides an easy and user-friendly space saving solution, wherein customers get to sign up and start processing their data immediately, identifying what is no longer needed and staging in a recycle bin where it can be archived, restored or permanently deleted.

### Autonomous File Management

The present invention may provide an Autonomous Predictive File Management System 800 that complements the Cloud-based AI Recycle Bin (AiRB) by providing an autonomous file management approach that enhances data lifecycle optimization. This system automates the management of redundant, obsolete, and trivial (ROT) files across various storage platforms, including local and cloud environments, leveraging artificial intelligence (AI) and machine learning (ML) technologies.

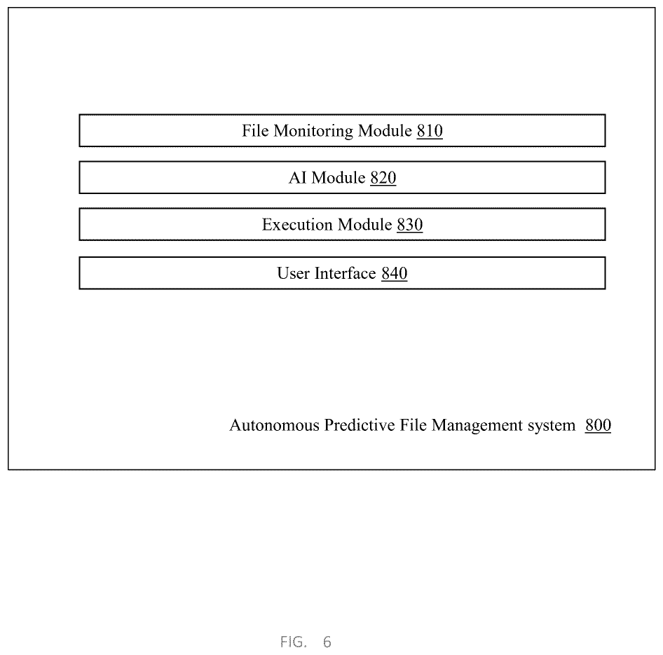

As shown in FIG. 6, the Autonomous Predictive File Management System 800 may comprise a File Monitoring Module, AI Module, Execution Module, and User Interface.

### File Monitoring Module 810:

This module continuously monitors file system activities, capturing pertinent metadata, content, and usage patterns across both local storage and cloud environments.
It ensures a comprehensive view of file utility by evaluating all types of data sources within an organization.

### AI Module 820:

Utilizing sophisticated machine learning algorithms and natural language processing (NLP), this module analyzes the collected data to predict the likelihood of future file utility. This can include using data clustering techniques, such as centroid-based, density-based, hierarchical and distribution-based clustering, to cluster like data based on its semantic meaning. Then using AI to identify the classification or data type of each cluster's centroid and mapping these to retention policies to identify how long to keep this type data before deleting or permanently archiving it.
By correlating file attributes, usage history, semantic content and mapped retention policies, the AI model learns to identify which files are redundant or no longer needed.

### Execution Module 830:

This component automatically implements file disposition recommendations based on predictions generated by the AI module, ensuring compliance with user-defined policies and operational thresholds.
Users can set parameters for file retention based on business rules or regulatory compliance, allowing the system to manage files autonomously while adapting to specific organizational needs.

### User Interface 840:

A user-friendly interface enables users to interact with the system effectively. It allows for the review of file disposition recommendations, adjustments to rules and policies, and manual file recovery options.
Users can also configure additional compliance and monitoring settings, ensuring the system aligns with organizational protocols.

### Operational Flow

### 1. Data Collection and Analysis:

The system continuously collects data from various sources, including local computers, enterprise servers, and cloud storage solutions.
Using machine learning, the system evaluates file metadata and patterns of usage to ascertain the probability of each file's future utility.

### 2. Predictive Management:

Based on the collected data, the AI module 820 generates predictions regarding which files should be archived, deleted, or retained.
The automation process minimizes the need for manual intervention, significantly reducing the resource burden on users while improving storage efficiency.

### 3. Adaptive Learning:

The system employs reinforcement learning that allows it to adapt to user behaviors and file management practices over time. This adaptability 6 ensures that the file management recommendations become more accurate and reliable as the model learns from real-world interactions and feedback.
   4. Integration with AiRB:
The Autonomous Predictive File Management System 800 serves as an additional functionality layer within the AiRB architecture, providing enhanced capabilities for file lifecycle management.
It can operate independently as a local solution or along with the AiRB cloud infrastructure, allowing organizations to leverage the strengths of both systems for comprehensive data management.

### Advantages

Comprehensive File Management: The integration of these two systems (where Autonomous Predictive File Management System 800 can be considered as a detailed file management focused system within the AiRB system) allows for the intelligent automation of file management, improving storage utilization and ensuring compliance with data governance policies.
User-Centric Approach: The system emphasizes user control and customization, enabling individuals or organizations to tailor file management strategies that align with specific data retention requirements or industry regulations.
Efficiency and Cost-Effectiveness: By automating the identification and management of ROT files, the system not only reduces the need for manual data housekeeping but also promotes significant cost savings by maximizing usable storage space and reducing data management overhead.

In one embodiment, the Autonomous Predictive File Management System 800 may comprise a file monitoring module 810 configured to collect file metadata and content data;
an artificial intelligence (AI) module 820 comprising a machine learning model, the AI module configured to:
   analyze the collected file metadata and content data;
   predict a probability of future file utility based on said analysis, wherein the prediction is generated by a model trained to recognize patterns correlating to file use and disuse;
   generate a file disposition recommendation based on the predicted probability, wherein the recommendation includes at least one of: archival, deletion, or compression; and
an execution module 830 configured to automatically execute the file disposition recommendation, subject to user-defined policies and thresholds.

In addition, in some embodiments, the AI module 820 may further comprise a natural language processing (NLP) component configured to extract semantic information from file content, and wherein the predicted probability of future file utility is determined at least in part based on the extracted semantic information.

In some embodiments, the AI module 820 may utilize a reinforcement learning algorithm to dynamically adjust the machine learning model based on user interactions with the execution module, thereby adapting the file disposition recommendations over time.

In some embodiments, the file monitoring module 810 may further monitor application usage and correlates application usage with file access patterns, and wherein the file usage data is incorporated into the prediction of future file utility.

In some embodiments, the execution module 830 provides a user interface for:
reviewing file disposition recommendations;
modifying user-defined policies and thresholds; and
recovering archived or deleted files.

In some embodiments, the system 800 may further comprise a cloud synchronization module configured to synchronize file disposition recommendations and archived files with a cloud-based storage service.

In some embodiments, the system 800 can be configured to identify and manage duplicate files based on file content hashing and metadata comparison.

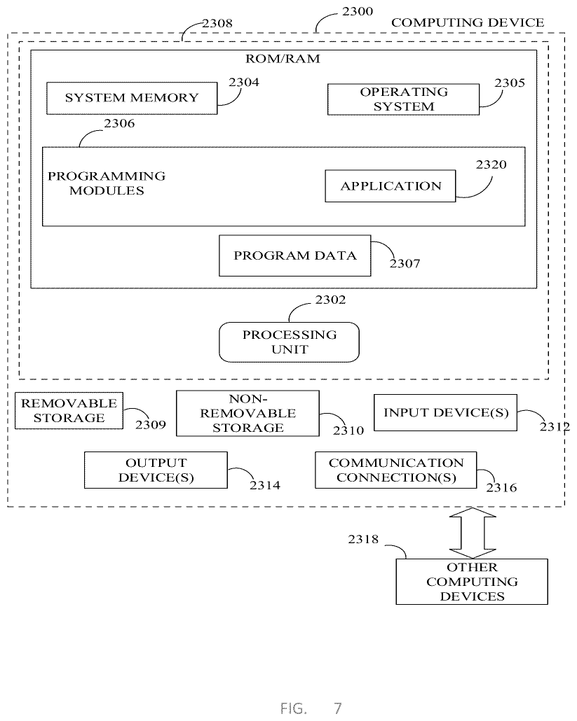

With reference to FIG. 7, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g. random-access memory (RAM)), non-volatile (e.g. read-only memory (ROM)), flash memory, or any combination. System memory 2304 may include operating system 2305, one or more programming modules 2306, and may include a program data 2307. Operating system 2305, for example, may be suitable for controlling computing device 2300's operation. In one embodiment, programming modules 2306, May include image-processing module, machine learning module. Furthermore, embodiments of the disclosure may be practiced along with a graphics library, other operating systems, or any other application program and is not limited to any particular application or system. This basic configuration is illustrated in FIG. 7 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 7 by a removable storage 2309 and a non-removable storage 2310. Computer storage media may include volatile and non-volatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2300. Any such computer storage media may be part of device 2300. Computing device 2300 may also have input device(s) 2312 such as a keyboard, a mouse, a pen, a sound input device, a touch input device, a location sensor, a camera, a biometric sensor, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2304, including operating system 2305. While executing on processing unit 2302, programming modules 2306 (e.g., application 2320 such as a media player) may perform processes including, for example, one or more stages of methods, algorithms, systems, applications, servers, databases as described above. The aforementioned process is an example, and processing unit 2302 may perform other processes.

Generally, consistent with embodiments of the disclosure, program modules May include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While some embodiments of disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

The following is claimed:

1. A system comprising:
a file monitoring module configured to collect file metadata and content data;
an artificial intelligence (AI) module comprising a machine learning model, the AI module configured to:
analyze the collected file metadata and content data;
predict a probability of future file utility based on said analysis, wherein the prediction is generated by a model trained to recognize patterns correlating to file use and disuse;
generate a file disposition recommendation based on the predicted probability, wherein the recommendation includes at least one of: archival, deletion, or compression; and
an execution module configured to automatically execute the file disposition recommendation, subject to user-defined policies and thresholds.

2. The system of claim 1, wherein the AI module further comprises a natural language processing (NLP) component configured to extract semantic information from file content, and wherein the predicted probability of future file utility is determined at least in part based on the extracted semantic information.

3. The system of claim 2, wherein the AI module utilizes a reinforcement learning algorithm to dynamically adjust the machine learning model based on user interactions with the execution module, thereby adapting the file disposition recommendations over time.

4. The system of claim 2, wherein the file monitoring module further monitors application usage and correlates application usage with file access patterns, and wherein the file usage data is incorporated into the prediction of future file utility.

5. The system of claim 1, wherein the execution module provides a user interface for:
reviewing file disposition recommendations;
modifying user-defined policies and thresholds; and
recovering archived or deleted files.

6. The system of claim 1, further comprising a cloud synchronization module configured to synchronize file disposition recommendations and archived files with a cloud-based storage service.

7. The system of claim 1, wherein the system is configured to identify and manage duplicate files based on file content hashing and metadata comparison.

8. A method comprising:
collecting file metadata, file content data, and file usage data;
analyzing the file metadata, file content data, and file usage data using an artificial intelligence module;
predicting the probability of future file utility utilizing the artificial intelligence module based on the combined analysis of the file metadata, file content data, and file usage data, wherein the AI leverages learned knowledge of compliance policies and retention schedules to determine whether to keep, archive, or delete a file;
generating file disposition recommendations based on the predicted probability; and
automatically executing the file disposition recommendations.

9. A method comprising:
displaying a user interface screen that allows a user to:
choose an initial system setting;
select a default configuration template for data management;
choose default data processing workflows to optimize file handling;
download and install scan agents on a plurality of devices, each of which is configured to operate within a network;
identify and grant permissions to a plurality of storage locations for each installed scan agent, ensuring secure access to all relevant data;
configure a target storage location for a recycle bin within a cloud storage platform, facilitating centralized data management;
schedule the scan agents to perform data scans and refresh these scans as a background service according to defined rules, ensuring continuous oversight of file utility;
review the resulting scan data, including file disposition recommendations generated by an artificial intelligence (AI) module, which provides suggestions for at least one of archival, deletion, or compression based on analyzed file utility;
receiving approval from a designated reviewer and generating results reflecting reviewer-approved decisions regarding file disposition;
copying the reviewer-approved results to the recycle bin to initiate the file management process;
prompting the reviewer to commit moves by confirming the deletion of the copied source data from the original storage locations;
performing operational commands to execute file management actions as decided by the reviewer;
running predefined rule patterns and search filters on existing scans and refreshed scans to enhance file retrieval;
configuring audits and presenting reporting dashboards to provide an overview of file management activities;
conducting auditing and reporting processes for oversight and compliance checks regarding file handling;
utilizing a natural language processing (NLP) module to extract semantic information from file content, enriching the analysis of file utility predictions;
scheduling automated billing and account management based on user-defined metrics and compliance requirements;
employing a reinforcement learning algorithm to dynamically adapt operational workflows based on user interactions and feedback; and
identifying and managing duplicate files through content hashing and metadata comparison techniques to ensure data integrity.

10. The method as claimed in claim 9, wherein the initial setting includes an account type, consumer and organization.

11. The method as claimed in claim 9, wherein the workflows include schedules for sending email ticklers to reviewers.

12. The method as claimed in claim 10, wherein a plurality of devices includes PCs and servers.

13. The method as claimed in claim 11, wherein a plurality of storage locations includes local, networked, and cloud storage locations for scanning.

14. The method as claimed in claim 11, wherein the configuration of the target recycle bin storage location includes an option to leave links in the local bin.

15. The method as claimed in claim 9, wherein the default configuration includes:
rules and Ai classifiers for identifying files (data) for cleansing including
consumer patterns for personal data files or
patterns based on industry templates containing relevant document types and regulatory retention requirements for an organization's data files.

16. The method as claimed in claim 15, wherein the method further includes a step of displaying a screen that allows the user to add additional admin and reviewer accounts.

17. The method as claimed in claim 15, wherein the method further includes a step of displaying a screen that allows the user to choose, third party cloud-2-cloud agents for scanning and processing data in third-party clouds through API integration services.

18. The method as claimed in claim 15, wherein the rules are configured for data volume limits, refresh cycles, dates, times for stopping, restarting scans due to network traffic and sending ticklers to reviewers for reviewing and taking action on results.

19. The method as claimed in claim 16, wherein the results include search filters and suggestions for approving and moving files to the recycle bin.

20. The method as claimed in claim 16, wherein performing operational commands for:
agents with additional data sources,
rules,
custom trainable Ai data classifiers,
default rules and search filters,
scans for cleansing and training custom classifiers, and
trained classifiers associated with rule patterns.
